(19) United States
(12) Patent Application Publication
(10) Pub. No.: US 2024/0401844 A1
(43) Pub. Date: Dec. 5, 2024

(54) SOLAR ENERGY COLLECTOR AND CONCENTRATOR SYSTEM

(71) Applicant: Manuel MUÑOZ SAIZ, Almeria (ES)

(72) Inventor: Manuel MUÑOZ SAIZ, Almeria (ES)

(21) Appl. No.: 18/032,981

(22) PCT Filed: Oct. 26, 2021
(86) PCT No.: PCT/ES2021/000036

§ 371 Date: May 14, 2024

(30) Foreign Application Priority Data
Oct. 27, 2020 (ES) U202000503
Dec. 7, 2020 (ES) U202000558
Jan. 8, 2021 (ES) U202100020
May 13, 2021 (ES) U202100230

(51) Int. Cl. F24S 20/20; C02F 1/14; C02F 103/08; C25B 9/67; F03G 6/00; F03G 6/06; F22B 1/00; F24S 10/70; F24S 23/30; F24S 23/70; F24S 23/74; F24S 30/425; F24S 50/20; F24S 50/60

(52) U.S. Cl. CPC F24S 20/20; C02F 1/14; F03G 6/06; F03G 6/129; F22B 1/006; F24S 10/70; F24S 23/31; F24S 23/745; F24S 23/80; F24S 23/82; F24S 30/425; F24S 50/20; F24S 50/60; C02F 2103/08; C02F 2201/009; C25B 9/67; F24S 2010/71

(57) ABSTRACT

The solar energy concentrator and collector system consists of a) longitudinal sheets, plates or bands of transparent plastic, carrying linear Fresnel lenses, b) longitudinal sheets, plates or bands of transparent plastic, carrying mirrors. Fresnel type or formed by multiple mini or linear reflective micro-mirrors integrated into them, b) sheets, plates or arched bands that carry multiple lenses or mini-lenses of cylinder segment section, c) mirrors arranged in a Fresnel type shape, d) of V-shaped mirrors, e) semi-parabolic mirrors of) plastic lenses filled with liquid, supported peripherally by cables, poles or a frame, which concentrate the solar rays in an equally longitudinal focus or duct, with a flattened ovoid or rectangular section. of large surface that carries a fluid, which when it is water evaporates, driving a turbine and goes to a generator.

### FIELD OF THE INVENTION

In renewable energies for high-power electricity generation and in the desalination of sea water.

### STATE OF THE ART

Currently, a large part of the energy radiated by the sun is concentrated and captured by power plants with large parabolic trough mirrors and increasingly lower-cost photovoltaic panels that, however, are still expensive. Desalination systems are expensive and expensive to maintain, with most stopping working overtime. The present system solves the mentioned problems.

### DESCRIPTION OF THE INVENTION

Objective of the invention and advantages.

Obtain energy in an economical and simple way.

Use a practical system, several times simpler and cheaper than the existing ones, which provides a large amount of energy allowing for large orchards or solar thermal power plants, and uses the largest existing linear lenses.

Take advantage of the large surface area of flattened oval or rectangular ducts, so corrections of lenses or mirrors are not necessary throughout the year, without loss of power.

It allows obtaining drinking water through desalination in large quantities and in an economical way.

Contributes to the protection of the environment (and birds) and prevents climate change.

Allow the use of fixed lenses, sheets or bands, which allow the sun's rays to be used even with the greatest deviations that occur during the solstices.

Contribute with a system that concentrates solar rays in a simple and useful economic way through mirrors, plastic lenses or lenses filled with a liquid.

Take advantage of the capture of solar rays with the East-West arrangement since with large inclinations (in the morning and evening) the only thing it affects is the point at which it does so longitudinally in the focal duct.

Problems to be solved The still high cost of current renewable energies and their equipment. Adding the difficulties of obtaining drinking water from sea water.

The solar energy concentrator and capture system of the invention, of the type that uses the reflection or refraction of solar rays through lenses or mirrors, consists of a) sheets, plates or longitudinal bands of transparent plastic, carrying Fresnel-type lenses. linear, b) sheets, plates or longitudinal bands of transparent plastic, carrying Fresnel-type mirrors, FIG. 1, or formed by multiple mini or micro linear reflective mirrors integrated into them, FIG. 2, b) sheets, plates or arcuate bands that carry multiple lenses or mini-lenses with a cylinder segment section, FIG. 3, c) mirrors arranged in a Fresnel type, FIG. 19, d) V-shaped mirrors, FIG. 12, e) semi-parabolic mirrors, FIG. 27 of) plastic lenses filled with a liquid, FIG. 14. Supported peripherally by cables and poles or a frame, which concentrate the solar rays in an equally longitudinal focus or duct, with an oval or ovoid or rectangular section. flattened large surface that runs along the ground or lower area, a fluid circulates through said conduit, which when it is water evaporates, driving a turbine and a generator, or being applied to a conduit that runs parallel and adjacent with saline water to its desalination, the water vapour is condensed and fed back into the system through a duct from the turbine outlet.

The plates, sheets or bands are held horizontally or inclined towards the direction of the ecliptic, using posts or bars on the sides. These posts are hinged at their base to allow retraction of plates, bands, etc., for maintenance or wind protection.

The mirrors and lenses of the sheets or bands have an inclination that increases towards the sides with respect to the vertical plane of symmetry of the focal channel

Sheets, bands, etc. are preferably fixed, longitudinally in the East-West direction, but they can be tilted laterally depending on the time or season of the year, but the use of fixed mirrors is permitted. For southern Europe the inclination is usually like the latitude, between 30° and 40°.

Electric actuators retract the bands, with cables when electromagnets are activated with a sensor formed by a fin and the action of the wind.

Optionally, the sheets or bands can also be tilted manually, with a sun-tracking servomechanism using a microprocessor or photoelectric cells. With actuators, three positions or inclinations can be applied, which correspond to different times of the year.

The ducts must be suitably thermally insulated, especially in their lower area. For the upper one it is enough to use the glass conduit.

The water is introduced into the pipes with pumps or from pressurized tanks fed with pumps as it evaporates. Subsequently, condensate is fed back into the system or into the tank, if there is a shortage. If used for desalination, the salt water evaporates using ducts parallel to the focal ones and condenses in condensers.

Wind protection is achieved by making the system foldable by rotating the posts which are articulated at their base. The sheets or bands can also be released by activating an actuator and retracted by the action of a spring.

The system can be placed in a channel made in the ground.

Sheets, bands and lenses can be manufactured with methacrylate, PMMA, polymethylmethacrylate, poly (methyl-2 methylpropenoate), simply called acrylic, it comes in granules for the injection or extrusion process and in plates for thermoforming or machining.

PMMA is a highly transparent thermoplastic polymer. It has half the density of glass. It is scratch resistant. Its transparency is around 93%. The most transparent of plastics. About ten to twenty times more resistant to impact than glass. Resistant to the weather and ultraviolet rays. There is no noticeable aging in its exterior exposure. It is a very good thermal and acoustic insulator. It does not produce toxic gas when burning. Great ease of machining and moulding, but they are made of hygroscopic material. Other cheaper plastics can be used, since being thin does little to affect transparency. Liquids such as mineral oils or others that tolerate high temperatures can be used for lenses.

Its linear shape allows it to be manufactured by extrusion and also with roller-shaped moulds that produce a continuous, rollable band.

All lenses, Fresnel type or those formed by multiple cylinder segment section lenses, etc. They can be hollow and filled with liquid.

Mirrors can be aluminized plastic sheets, metallized polyethylene terephthalate or aluminized PET (Mylar) plastic.

Energy storage can be done pneumatically with containers on the seabed or by storing heat using molten salts.

### BRIEF DESCRIPTION OF THE DRAWINGS

FIG. 1 shows a schematic and cross-sectional view of a sheet, plate or longitudinal band with a Fresnel-type lens with the solar rays concentrated on an area of the focal duct with a very wide oval section that allows the capture of the solar radiation with a large apparent inclination of the sun with respect to the equinoctial plane of the place. It also allows lower heights.

FIG. 2 shows a schematic and cross-sectional view of a sheet, plate or longitudinal band with multiple micro or mini mirrors, with the solar rays concentrated on an area of the focal duct with a very wide oval section.

FIG. 3 shows a schematic, sectional view of a collector of a sheet, plate or curved longitudinal band, formed by multiple lenses.

FIGS. 4, 14, 19, 20, 24 and 25 show cross-sectional views of focal duct variants and their incident rays.

FIGS. 5, 6 and 18 show schematic plan views and partially sectioned views of concentrator plant variants.

FIGS. 7 to 10 show schematic and sectional views of variants of concentrator systems.

FIG. 11 shows a schematic, perspective and partial view of an arrangement of a solar thermal plant on the ground.

FIG. 11a shows a schematic view of a manufacturing system for sheets, plates or bands.

FIG. 11b shows the roller that shapes the Fresnel-type band.

FIG. 11c shows the roller shaping the arcuate band of cylinder segment section multi-lenses.

FIG. 12 shows a pair of V-shaped mirrors.

FIG. 13 shows a perspective view of V-shaped mirrors.

FIGS. 15 and 16 show schematic views of variants of plastic lens systems filled with a liquid.

FIG. 17 shows a schematic and partially sectioned view of a type of lens which curves when an area of it is inflated.

FIGS. 21 and 22 show schematic and partially sectional views of a mirror fastening system.

FIG. 23 shows a schematic plan view of the arrangement of mirrors and their attachment.

FIG. 26 shows different sectional views of duct variants.

FIGS. 27 and 28 show variants of semi-parabolic mirrors.

FIGS. 29 and 30 show variants of extension and retraction systems for the mirrors.

### MORE DETAILED DESCRIPTION OF AN EMBODIMENT

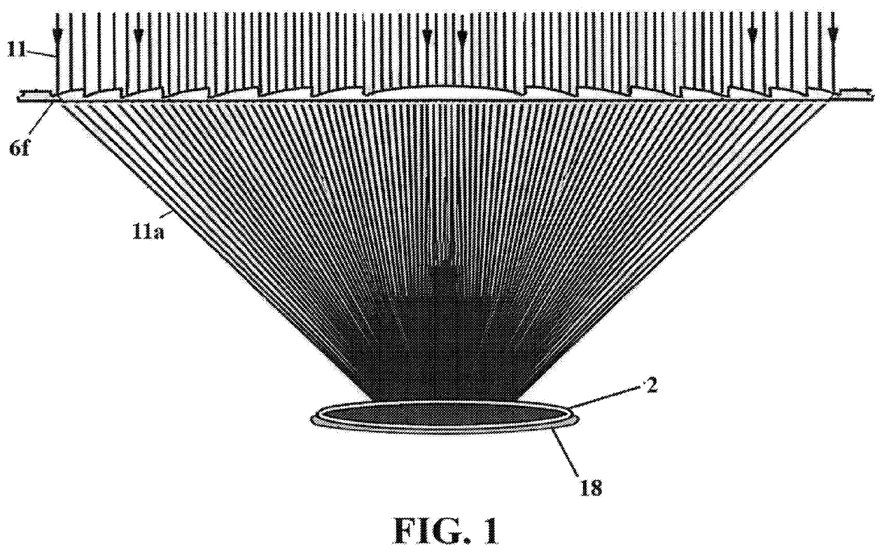

FIG. 1 provides a possible embodiment of the invention, with the solar rays (11) incident on the Fresnel-type lens. formed by a transparent sheet, plate or band (6f), with concentrates (11a) emerging towards a portion of the wide focal duct of ovoid section (2), which may be rectangular. This has a much larger surface area, less concentration, which is why it requires less precision and the performance obtained is the same. The duct is made of glass, which in addition to being thermal insulating adds another thermal insulator (18) in its lower external area in contact with the ground.

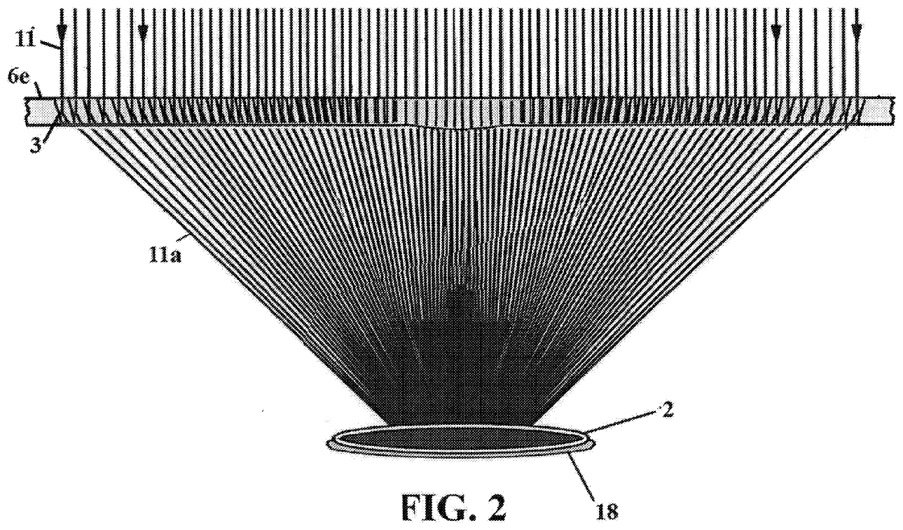

FIG. 2 shows the solar rays (11) incident on the mirrors (3) supported integrated into the plate, band, sheet or transparent sheet (6e), leaving reflected (11a) towards the wide duct or focus of ovoid section (2), which can be rectangular. This one has a large surface area, the concentration is lower, but it requires less precision and the performance obtained is the same. The duct is made of glass, which in addition to being thermal insulating adds another thermal insulator (18) in its lower area in contact with the ground. As can be seen, the mini or micro-mirrors are integrated into the transparent sheet and are made up of thin sheets of reflective metals.

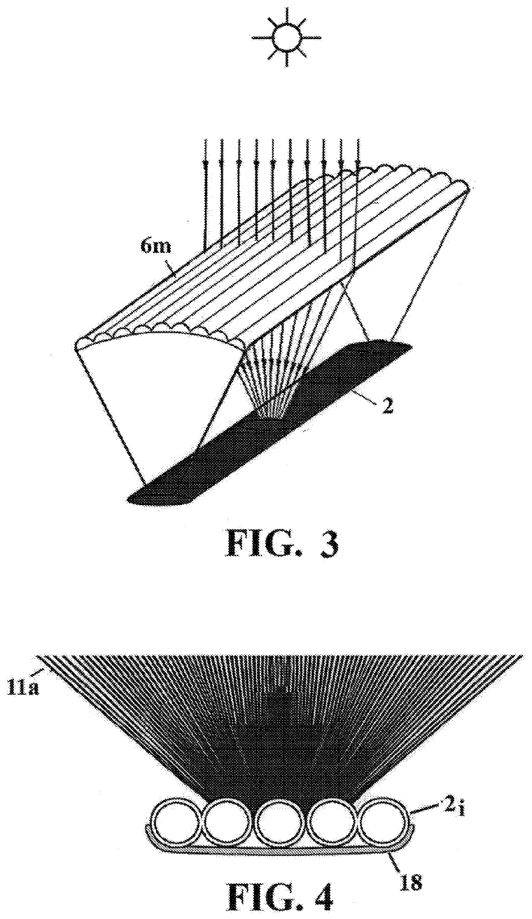

FIG. 3 shows the arched plate (6m) formed by multiple lenses supported from the corners and edges by posts and arranged on the focal duct (2).

FIG. 4 shows the solar rays (11a) concentrated by lenses, towards the cylindrical focal ducts (2i), in this case the central ones of a group of several laterally attached ducts. They can also be square section. It carries the thermal insulator (18) in the lower area.

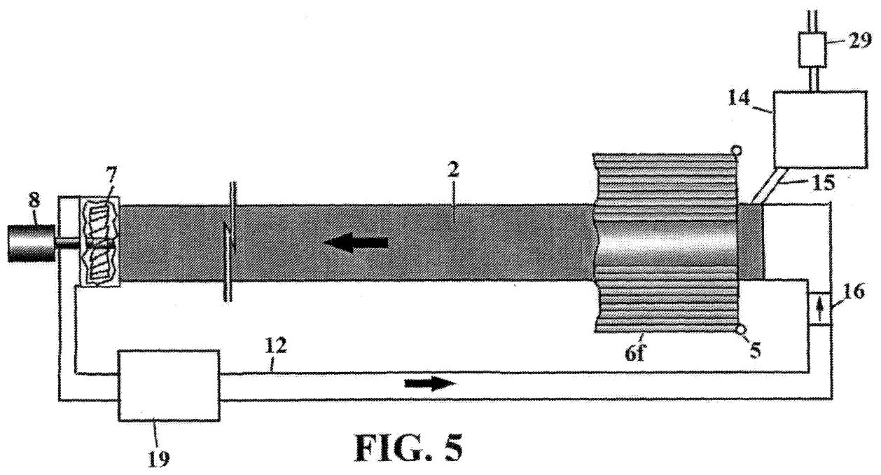

FIG. 5 shows the water pump (29) that feeds and maintains pressurized the water tank (14) that communicates and feeds the focal conduit (2) through the conduit (15). It shows the Fresnel type sheet or band (6f) supported by its corners and edges by the posts (5), on the focal duct, which discharges the fluid onto the turbine (7) that drives the electric generator (8). After passing the turbine, the fluid condenses in the condenser (19) and is fed back through the conduit (12) through the check valve (16) that prevents the return of the fluid.

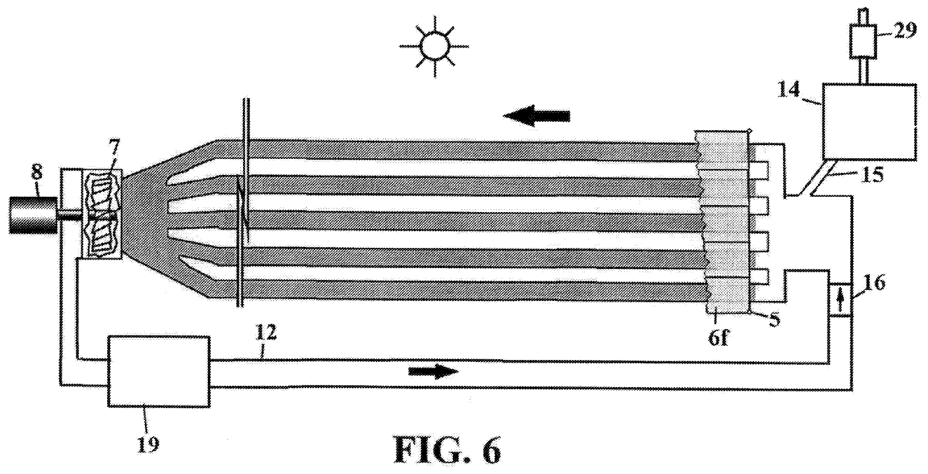

FIG. 6 shows the water pump (29) that feeds and maintains pressurized the water feed tank (14) that communicates and feeds with the conduit (15) to multiple focal conduits heated by the Fresnel-type lens bands (6f). supported by its corners and edges by the posts (5). The water vapour is discharged onto the turbine (7) that drives the electric generator (8). After passing the turbine, the fluid condenses in the condenser (19) and is fed back through the conduit (12) through the check valve. (16) that prevents the recoil of the fluid.

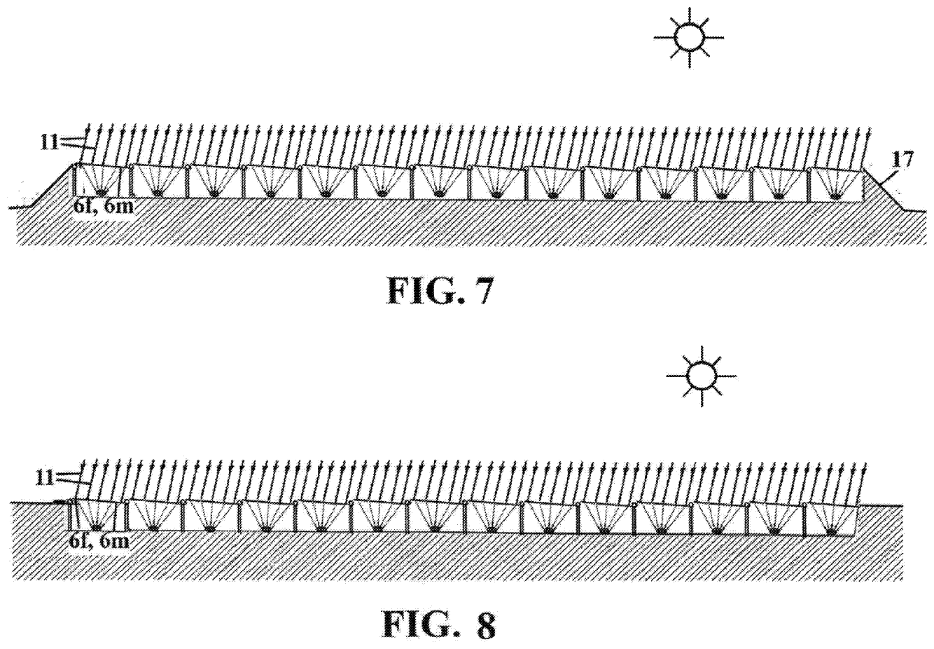

FIG. 7 shows a thermal plant formed by the sheets, plates or support bands (6f, 6m) that receive the inclined rays (11) of the sun of a solstice. They are protected in their sides by the terrain ramps (17).

FIG. 8 shows a plant formed by the sheets, plates or support bands (6f, 6m) that receive the inclined rays (11) of the sun of a solstice. They are protected by a channel made on the ground, leaving the sheets at ground level.

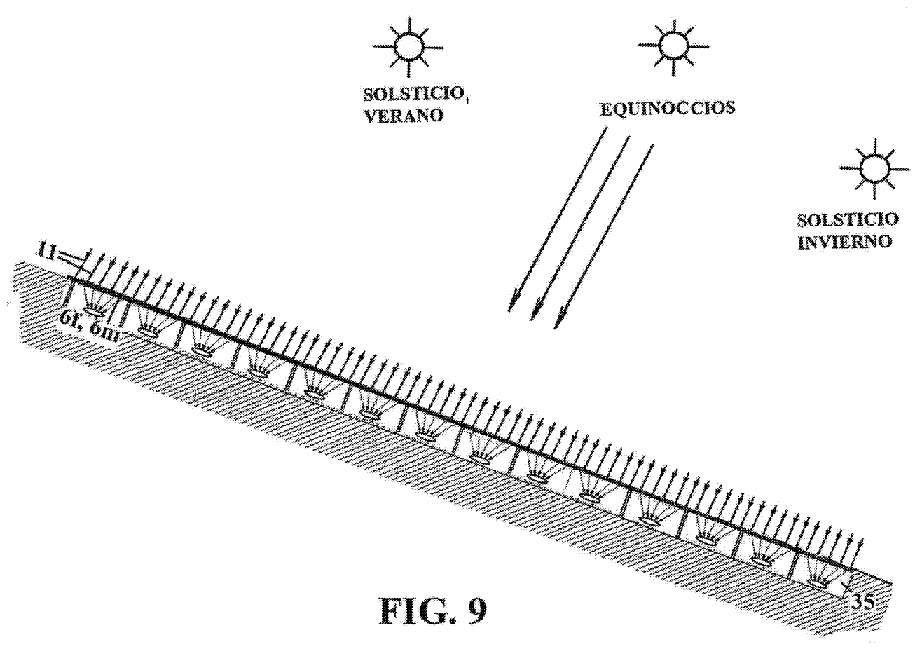

FIG. 9 shows a plant formed by the sheets, plates or support bands (6f, 6m) housed in a channel made on the side of a mountain, which receive the rays perpendiculars (11) of the equinoxes. They are protected by a channel (35) made in the ground, leaving the sheets at ground level.

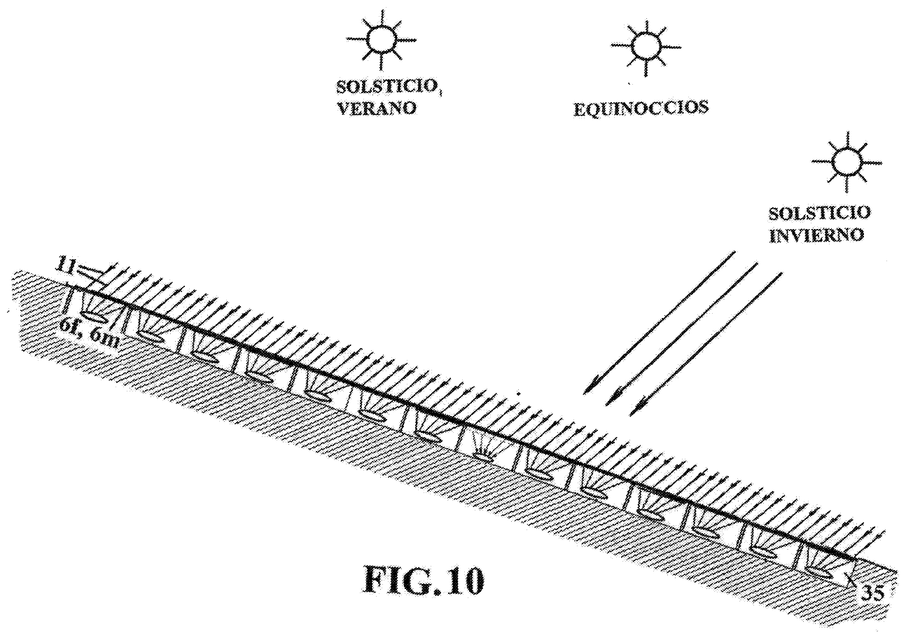

FIG. 10 shows a plan formed by the sheets, plates or support bands (6f, 6m) housed in a channel made on the slope of a mountain, which receive the inclined rays (11) of the winter solstice. They are protected by a channel (35) made in the ground, with the sheets remaining flush with it.

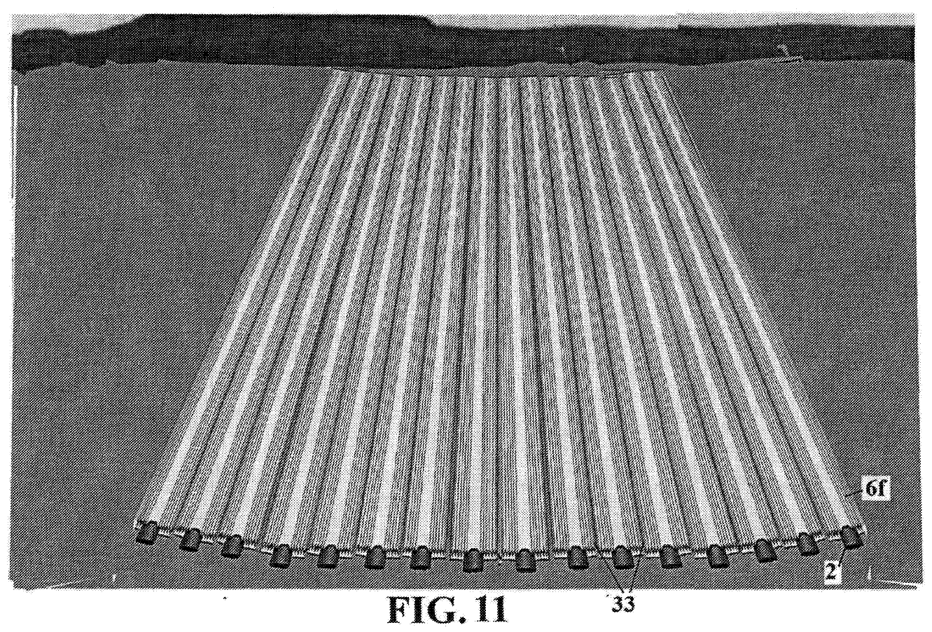

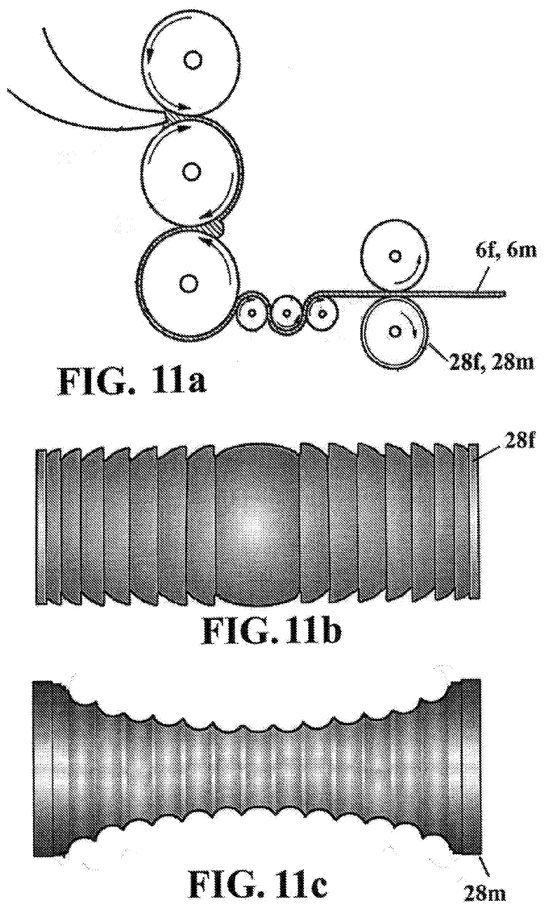

FIG. 11 shows a plan formed by the bands (6f) and their focal ducts (2), the bands being supported laterally by their flanges with the supports (33).

FIG. 11a shows a series of rollers between which the lens sheet is produced and when passing between the last rollers (28f, 28m) that carry the relief, the linear lens (6f, 6m) is produced. To prevent deformation by the last rollers or air currents, cold is applied to them to cool them.

FIG. 11b shows the roller (28f) which applies the shape or relief of a linear Fresnel lens to one of the surfaces of the sheets or bands.

FIG. 11c shows the roller (28m) which applies the arched shape or relief of multiple cylinder segment section lenses to one of the surfaces of the sheets or bands.

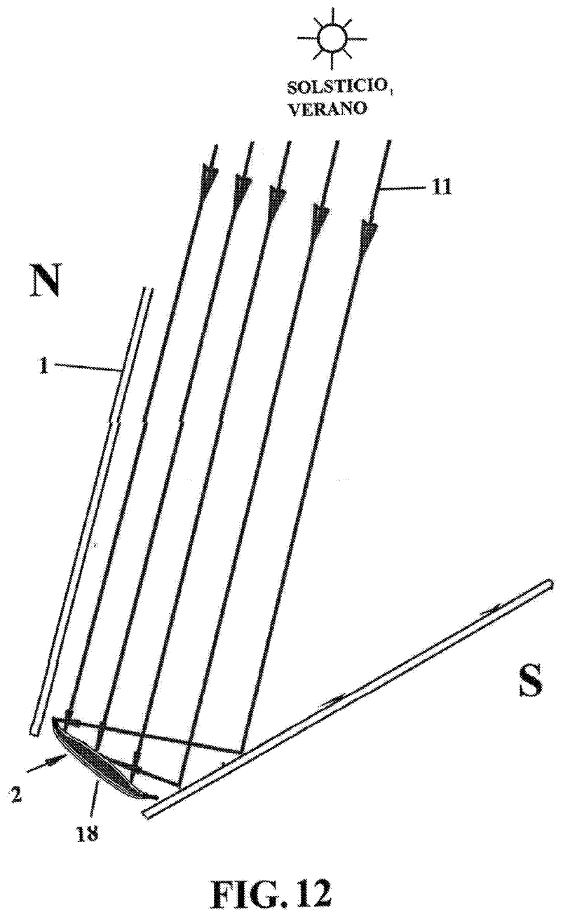

FIG. 12 shows the solar rays (11) incident on the sheets or plates (1), mirrors that concentrate the rays of the summer solstice sun on the focal duct with an ovoid section (2). The duct is made of glass, which also If it is a thermal insulator, it adds another thermal insulator (18) in its lower area in contact with the ground.

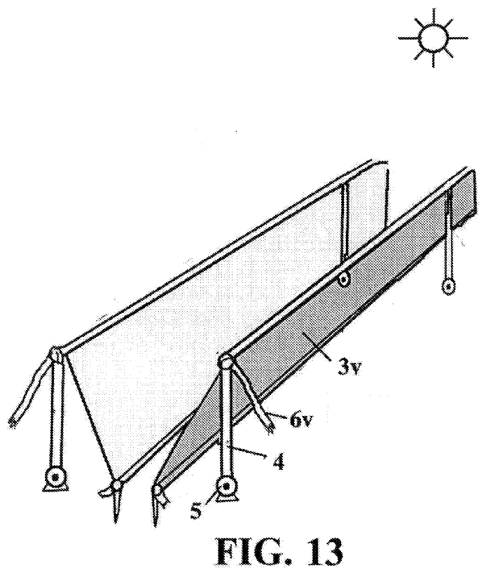

FIG. 13 shows the pair of V-shaped mirrors formed by the sheets (3v), the cables (6v) on their periphery, supported by the posts (4) which carry the joint (5) together with its base.

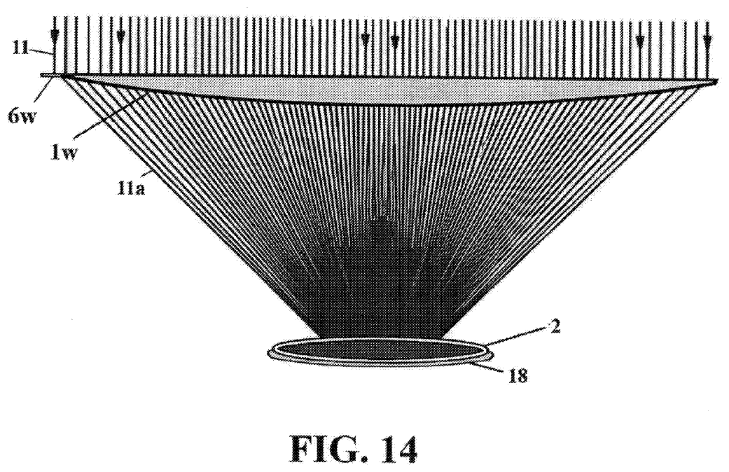

FIG. 14 shows the solar rays (11) incident on a plastic lens (1w) filled with liquid, its periphery supported by the sheets or bands (6w) emerging refracted towards the ovoid section focal duct (2). The duct carries a thermal insulator (18), in its lower area in contact with the ground. The lens can be formed only by its face or lower wall and the liquid.

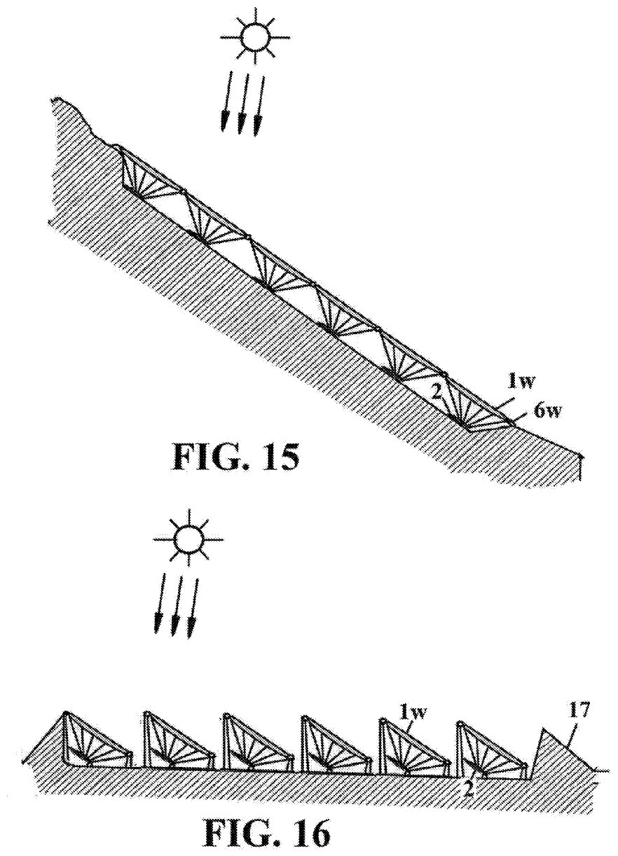

FIG. 15 shows a plant on a channel on the side of a mountain, formed by several bands (6w) and liquid lenses (1w), which receive the inclined solar rays of a solstice and are concentrated on the sides of the focal ducts. (2).

FIG. 16 shows a plan formed by multiple bands (6w) each with an inclined lens (1w) that concentrate the solar rays on a solstice. It is formed by the liquid lenses (1w), which receive the inclined solar rays during a solstice and are concentrated on the sides of the wide focal ducts (2). On a horizontal surface and protected by the terrain ramps (17).

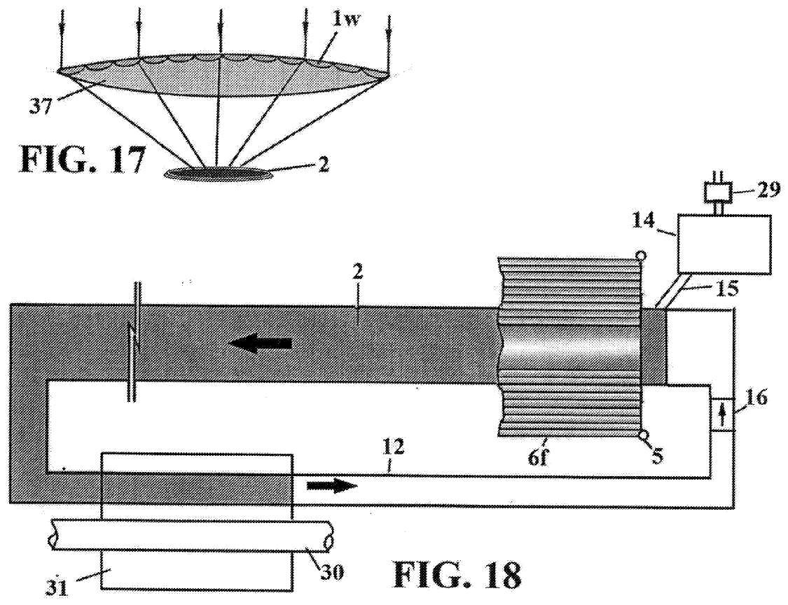

FIG. 17 shows the lens formed by multiple mini-lenses (1w) filled with liquid, curved by inflating the chamber (37) with air, which concentrates the rays on an area of the lens (2). This bending by pressurized air is valid for other types of lenses or mirrors. Ribs can be added that oppose the bulging.

FIG. 18 shows the water pump (29) that feeds and maintains pressurized the water supply tank (14) that communicates and feeds through the conduit (15) to the focal conduit (2), conduit heated by the Fresnel-type band (6f) supported by its corners and edges by the posts (5). The water vapour is fed back through the conduit (12) through the valve (12) before passing parallel to the conduit (30), into the chamber (31) that carries saline water for desalination.

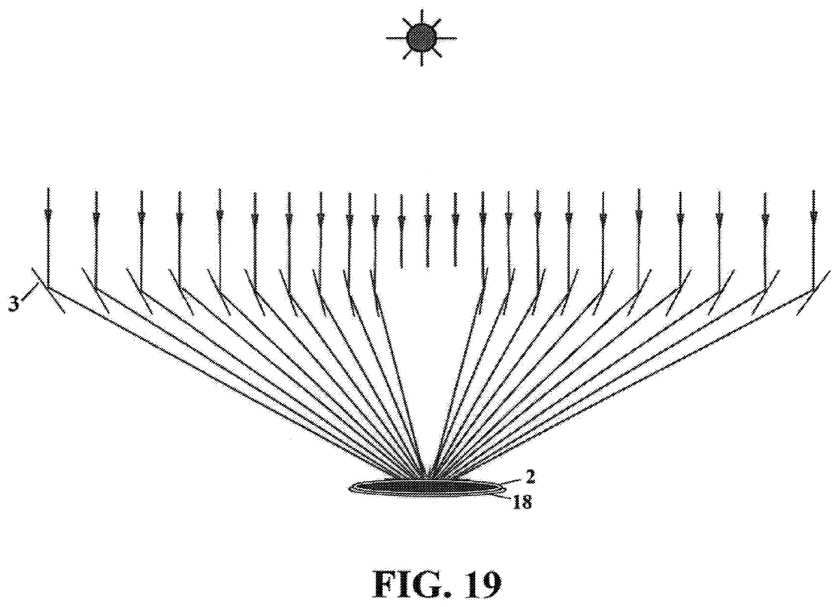

FIG. 19 shows the mirrors (3), the focal duct (2), the insulating element (18) and the sun at the equinox.

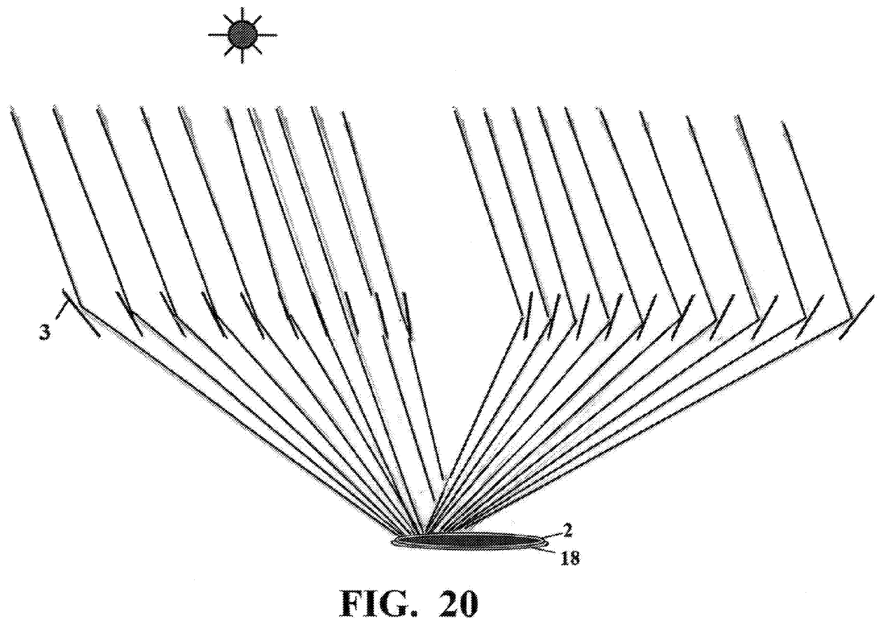

FIG. 20 shows the mirrors (3), the focal duct (2), the insulating element (18) and the sun at the time of a solstice.

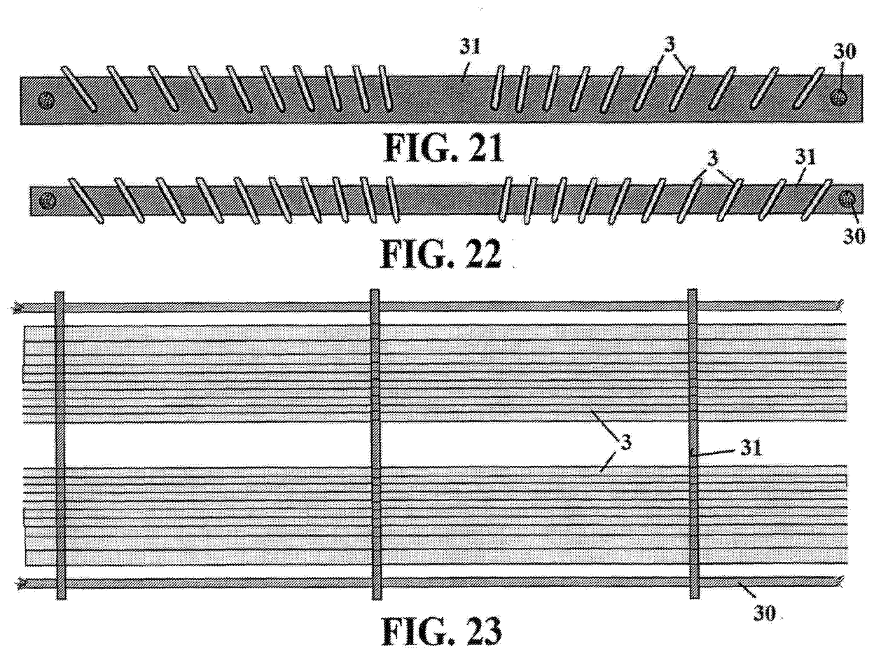

FIG. 21 shows the crossbars (31) for holding the mirrors (3) and which is supported by the cables (30) and these from the ends of some posts.

FIG. 22 shows the crossbars (31) for holding the mirrors (3) supported by the cables (30). Here the mirrors are attached and secured differently than in FIG. 21.

FIG. 23 shows the crossbars (31) for holding the mirrors (3) and supported by the cables (30).

FIG. 24 shows the solar rays (11) incident on the mirrors (6f), the ovoid and vertical focal duct (2a). This allows the lower mirrors to be placed.

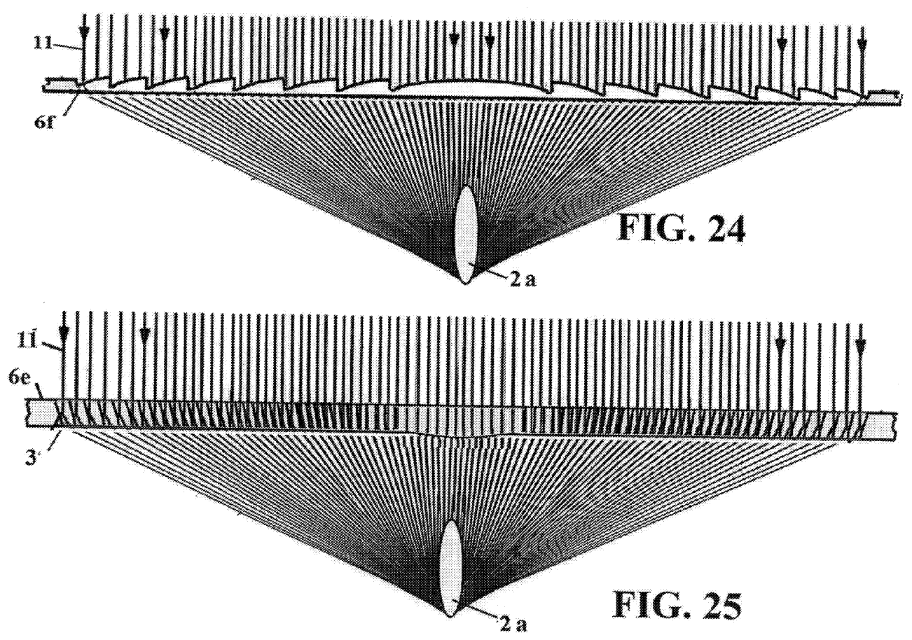

FIG. 25 shows the solar rays (11) incident on the mirrors (3) supported integrated into the plate (6c), the ovoid and vertical focal duct (2a).

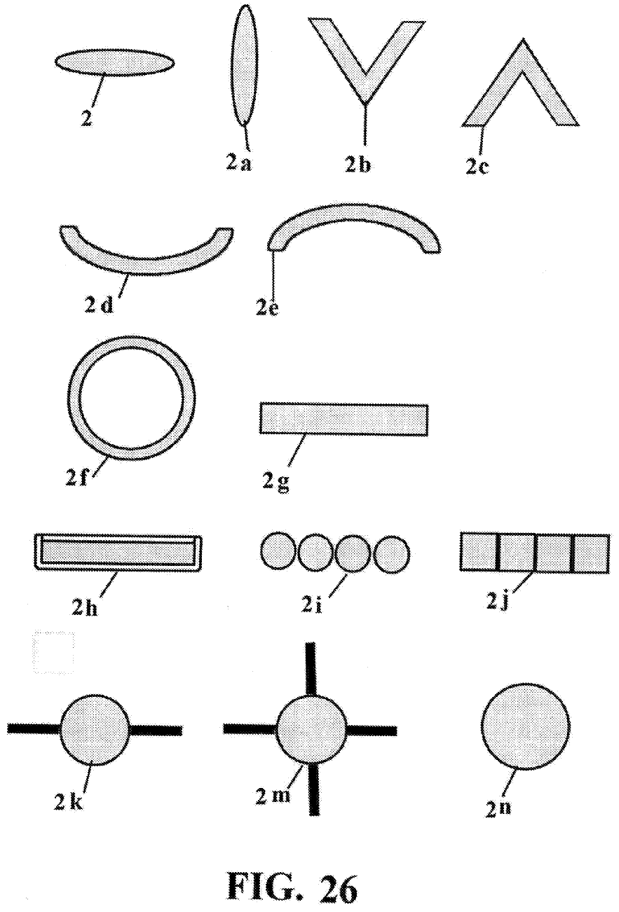

FIG. 26 shows the different focal ducts with different sections (2, 2a, 2b, 2c, 2d, 2e, 2f, 2g, 2h, 2i. 2j, 2k, 2m and 2n) that provide a large surface area.

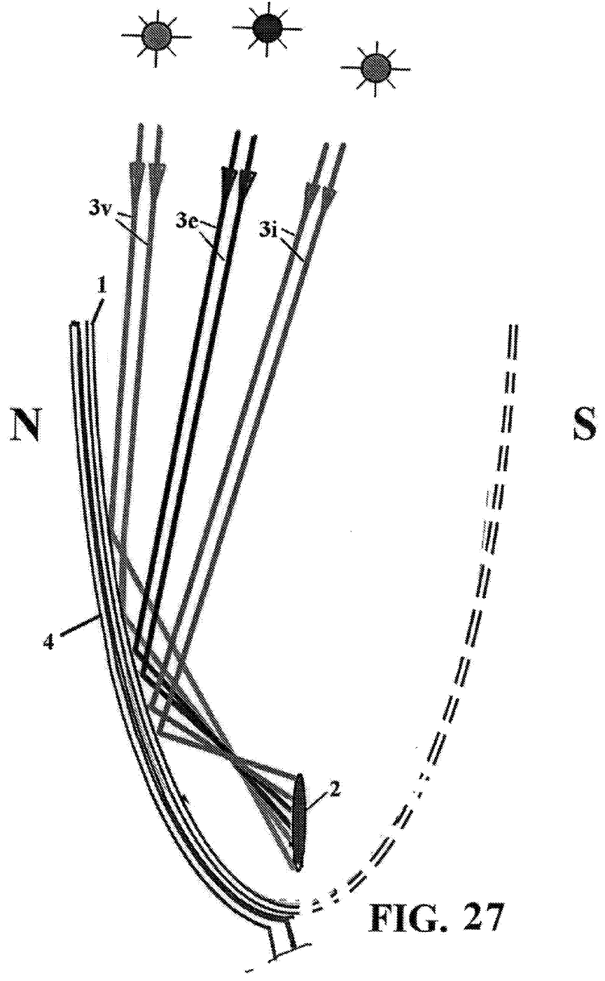

FIG. 27 shows the solar rays (3v, of the summer solstice) (3e, of an equinox) (and 3i, of the winter solstice, all this for the northern hemisphere, incident on the mirror (1) that reflects and concentrates them in the semi-parabolic cylindrical focal duct (2), with an elliptical or oval section. The mirror (1) is supported by the posts (4) at the ends and some cables not shown in the figure. The north (N) and the south (S) are to determine its geographical orientation.

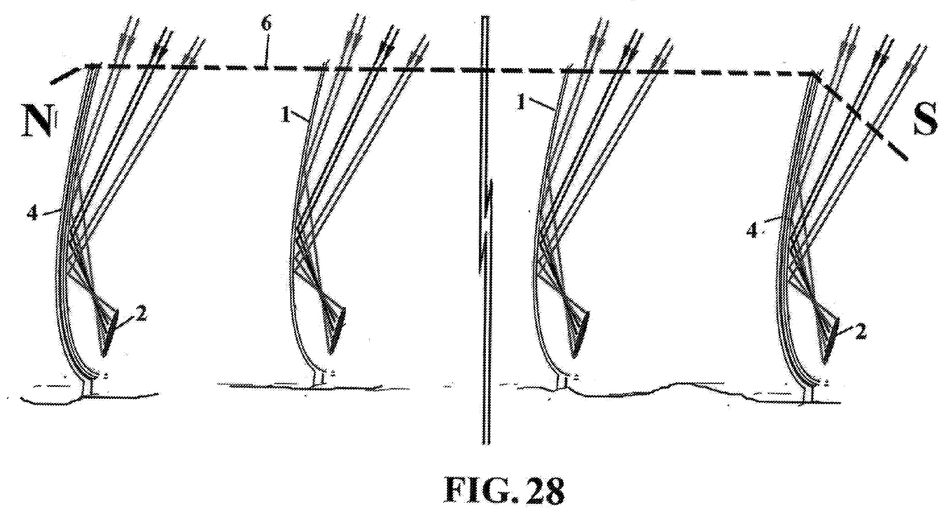

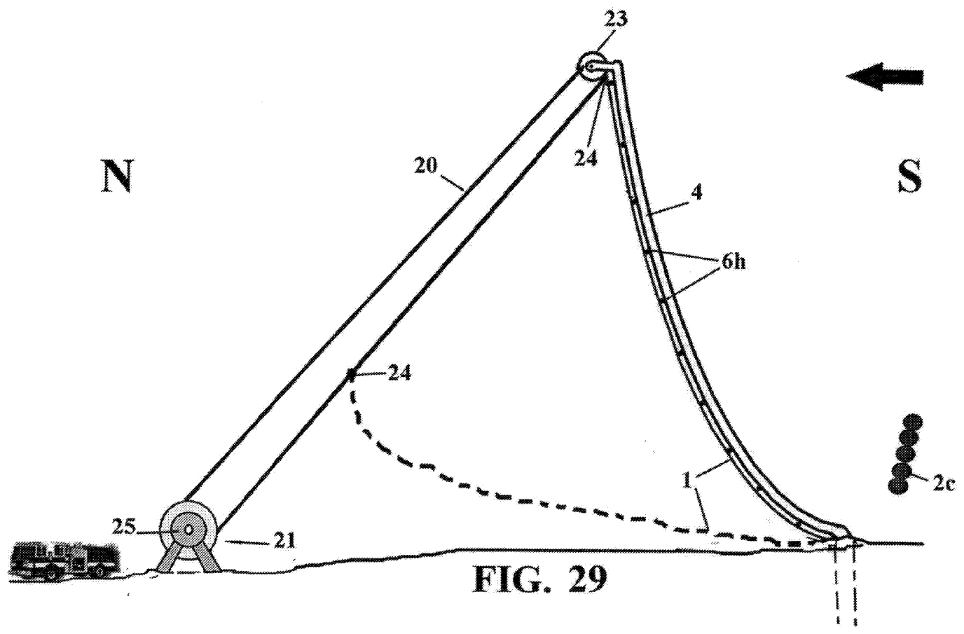

FIG. 28 shows several rotating or tilting mirrors (1) and attached to their upper edge by the cables (6). The cables are attached to their ends by the posts (4), with their end flexible bottom, which are tiltable using the cable (6). The solar rays hit the mirrors and are concentrated on the focal duct (2). North (N) and south(S) are to determine its geographical orientation.

The FIG. 29 shows the post (4) that supports the horizontal cables (6h) at its ends, which in turn support the semi-cylinder-parabolic mirror (1), which is retracted for wind protection by means of the cable or belt (20) that runs between the winch pulley (21) and the pulley (23) at the upper end of the mast, thereby moving the connection point (24) between the cable (20) and the mirror (1). During its collection the mirror is shown with the dashed line. Shows the focal ducts (2c) and geographic points (N and S).

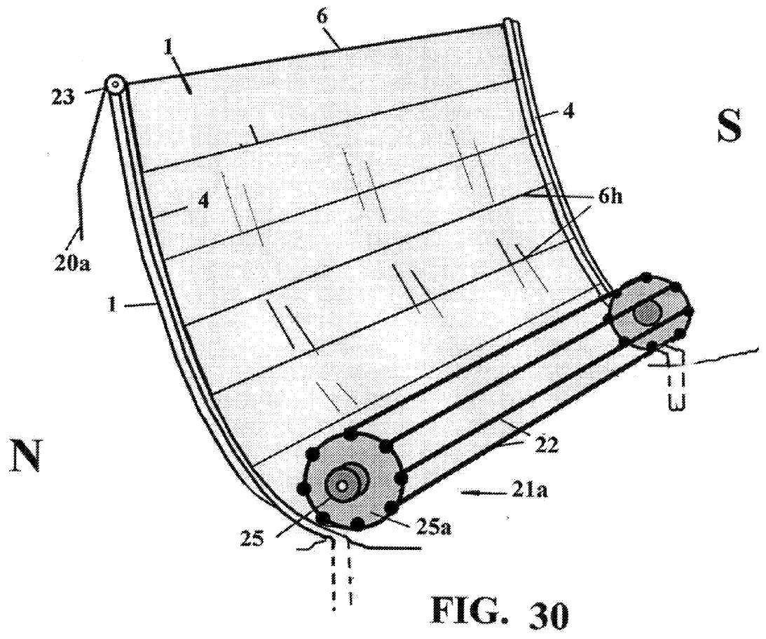

FIG. 30 shows two posts (4) between which the horizontal cables (6h and 6) are arranged that support the mirror (1) and give it shape. When the roller formed by some discs (25a) and the cables (22) rotates between its peripheries, the mirror (1) is wound, helped by the pulley (23) and the cable (20a), which by means of a motor or a spring keeps it tight. Shows the geographic points (N and S).

1. A solar energy concentrator and capture system, of the type that uses the reflection and refraction of solar rays through lenses or mirrors, comprising a) sheets, plates or longitudinal bands of transparent plastic, carrying Fresnel-type lenses. linear, b) sheets, plates or longitudinal bands of transparent plastic, carrying Fresnel-type mirrors or formed by multiple mini or micro linear reflective mirrors integrated into them, b) sheets, plates or arched bands that carry multiple lenses or mini-lenses of cylinder segment section, c) mirrors arranged in a Fresnel type shape, d) V-shaped mirrors, semi-parabolic mirrors or plastic lenses filled with a liquid, supported peripherally by cables and posts or a framework, which concentrates the solar rays in an equally longitudinal focus or conduit, with an oval or ovoid, or flattened rectangular section, with a large surface area that runs along the ground or lower area, through said conduit a fluid circulates, which when it is water is evaporates, drives a turbine and is to a generator, or is applied to a conduit that runs parallel and adjacent with saline water for desalination, the water vapour is condensed and fed back into the system through a conduit from the turbine outlet.

2. The system as claimed in claim 1, wherein the lenses, plates, sheets or bands are held horizontally or slightly inclined towards the north or towards midday, by means of posts or bars on the sides.

3. The system as claimed in claim 1, wherein the Fresnel-type mirrors adopt an inclination that increases towards the sides with respect to the vertical plane of symmetry of the focal duct.

4. The system as claimed in claim 1, wherein the lenses, mirrors: sheets, bands or fabrics are preferably placed fixed, longitudinally in the East-West direction, corrected for the solar declination of the place, the angle formed by the Sun-Earth line and the plane of the celestial equator, projection of the terrestrial equator.

5. The system as claimed in claim 1, wherein the mirrors: sheets, bands or fabrics are laterally tiltable depending on the time or season of the year by means of a processor, microprocessor or photoelectric cell and a servo system.

6. The system as claimed in claim 5, wherein instead of tilting the mirrors, the focal ducts move.

7. The system as claimed in claim 1, wherein the lenses or mirrors are given three fixed positions.

8. The system as claimed in claim 1, wherein the ducts are thermally insulated, especially in their lower area, in the upper area with a transparent insulator such as the glass of the duct.

9. The system as claimed in claim 1, wherein the micro or mini-mirrors are integrated into the support plate, band or sheet, and the mirrors adopt an inclination that increases towards the sides with respect to the vertical plane of symmetry of the focal duct and are formed by light or thin sheets or layers of reflective metals.

10. The system as claimed in claim 1, wherein the lenses are formed by multiple mini-lenses and an inflatable chamber, which curve when one of their chambers is inflated with air.

11. The system as claimed in claim 1, wherein the semi-parabolic mirrors: sheets, bands or fabrics are supported on a grid of vertical cords attached to the parallel cables of the upper and lower edges, and these between the curved or straight posts or bars. which give a curved or flat shape to the mirrors, and are directed towards the sun of the equinoxes when they are fixed or inclined in the plane of the ecliptic.

12. The system as claimed in claim 1, wherein are used aluminized plastic sheets, metallized polyethylene terephthelate or aluminized PET (Mylar) plastic mirrors as mirrors.

13. The system as claimed in claim 1, wherein the plastic lenses are hollow and filled with a liquid, mineral oils or others that tolerate high temperatures.

14. The system as claimed in claim 1, wherein the plastic lenses are held at their periphery by means of cables, posts, rods or plates.

15. The system as claimed in claim 1, wherein the sheet, plate or band or lens is placed inverted with the lenses, striated surface or its relief towards the lower area.

16. The system as claimed in claim 1, wherein to protect against wind of a certain intensity, the sheets or bands are automatically released, an actuator is activated and they are retracted by the action of a spring.

17. The system as claimed in claim 1, wherein it has actuators that automatically release the sheets or bands, which are retracted by the action of a spring.

18. The system as claimed in claim 1, wherein acrylic that is presented in granules is used for the injection process, allowed by its linear shape and producing a continuous and rollable band.

19. The system as claimed in claim 1, wherein acrylic that is presented in granules is used for the extrusion process using roller-shaped moulds, allowed by its linear shape and producing a continuous and rollable band.

20. The system as claimed in claim 1, wherein the lens sheets and bands are produced using roller-shaped moulds.

21. The system as claimed in claim 1, wherein the posts have an articulated base, allowing the retraction of the sheet, band or fabric mirrors.

22. The system as claimed in claim 1, wherein the posts have a flexible lower end allowing the retraction of the sheets, bands or fabrics.

23. The system as claimed in claim 1, wherein the semi-parabolic mirrors are retracted by winding around impellers using electric motors.

24. The system as claimed in claim 1, wherein the protection against wind is carried out by automatically releasing the mirrors, sheets or bands.

25. The system as claimed in claim 1, wherein the focal duct is replaced by a group or row of several laterally attached ducts, ducts with a circular or square section.

26. The system as claimed in claim 1, wherein pumps introduce pressurized water into pressurized tanks, from where the focal conduits are fed, which is done automatically.
